(19) United States
(12) Patent Application Publication
(10) Pub. No.: US 2012/0223672 A1
(43) Pub. Date: Sep. 6, 2012

(54) BATTERY CHARGING DEVICE AND CHARGING METHOD THEREOF

(75) Inventor: CHIA-I LIU, Tu-Cheng (TW)

(73) Assignee: HON HAI PRECISION INDUSTRY CO., LTD., Tu-Cheng (TW)

(21) Appl. No.: 13/217,283

(22) Filed: Aug. 25, 2011

(30) Foreign Application Priority Data
Mar. 4, 2011 (CN) 201110052230.9

(51) Int. Cl. H02J 7/04; H02J 7/00

(52) U.S. Cl. 320/107; 320/152

(57) ABSTRACT

A battery charging device is provided for charging a rechargeable battery. A first reference battery temperature T_{C1}, a second reference battery temperature T_{C2}, a first reference charging voltage V_{C1}, and a second reference charging voltage V_{C2} are established. The device includes a detecting unit, a comparing unit, and a charging control unit. The detecting unit detects the charging voltage V_{C} and the battery temperature T_{Bat} of the rechargeable battery. The comparing unit compares the detected temperature T_{Bat} with temperatures T_{C1} and T_{C2}, or compares the detected voltage V_{C} with voltages V_{C1} and V_{C2}. The charging control unit adjusts the Vc as required based on the comparison results, to adjust a value of a constant current I while charging the rechargeable battery in a constant current charging phase.

### BACKGROUND

1. Technical Field

The present disclosure relates to battery charging devices and, more particularly, to a battery charging device capable of protecting a battery when the battery is charged and a charging method thereof.

2. Description of Related Art

A conventional portable electronic device, for example a mobile phone, an MP3 player, or a Personal Digital Assistant (PDA), often includes a rechargeable battery to supply power to the device.

Referring to FIG. 1, a graph showing a traditional battery charging process for recharging a rechargeable battery is illustrated. The charging process includes a constant current charging phase (CCC phase) and a constant voltage charging phase (CVC phase). When the charging process begins, the battery is firstly charged in the CCC phase to reach a first critical voltage V₁, then the battery is charged in the CVC phase until the charging current I_{C} has decreased to zero. At this point, the battery is charged fully and the charging process ends. To protect the battery, when the battery is in an over-discharged state, that is, when the battery voltage V_{Bat} is less than a second critical voltage V₂ which is less than the first critical voltage V₁, the battery is firstly trickle charged to cause the battery voltage V_{Bat} to reach the second critical voltage V₂, and then the battery is charged in the CCC phase. The constant current in the CCC phase will cause the battery temperature T_{Bat} to increase and the charging voltage V_{C} to change continually. In the conventional charging process, charging the battery is mostly done in the CCC phase, and in order to prevent the battery from exploding when being charged, if the temperature T_{Bat} of the battery reaches a protection temperature T_{P} or the charging voltage V_{C} reaches a protection voltage V_{P}, the charging process will end altogether, which may leave the battery less than fully charged.

It is thus desirable to provide a battery charging device capable of protecting a battery all the way to the point when the battery is fully charged and a charging method thereof to address the limitations described above.

### BRIEF DESCRIPTION OF THE DRAWINGS

The components in the drawings are not necessarily drawn to scale, the emphasis instead being placed when clearly illustrating the principles of the present disclosure. Moreover, in the drawings, like reference numerals designate corresponding parts throughout the several views.

FIG. 1 is a schematic view of a graph showing a traditional battery charging process for recharging a rechargeable battery.

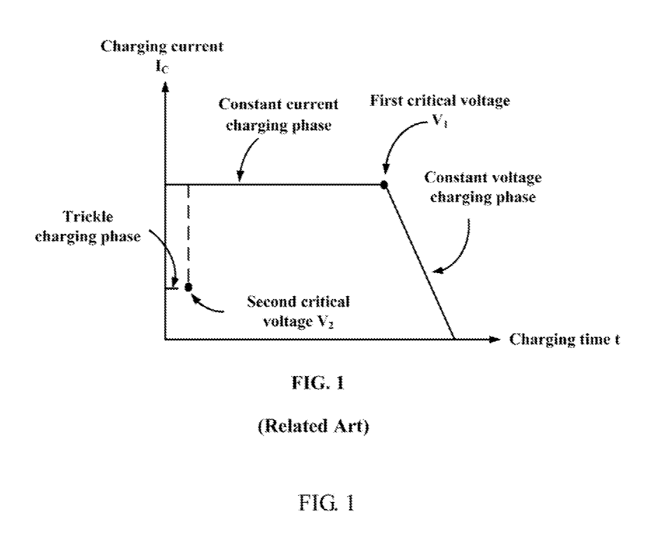

FIG. 2 is a block diagram of a battery charging device in accordance with an exemplary embodiment.

FIG. 3 is a flowchart of a charging method for charging a rechargeable battery in a constant current charging phase in accordance with an exemplary embodiment.

FIG. 4 is a flowchart of a method for adjusting the constant current value in the charging method of FIG. 3.

### DETAILED DESCRIPTION

The disclosure is illustrated by way of example and not by way of limitation. It should be noted that references to “an” or “one” embodiment in this disclosure are not necessarily to the same embodiment, and such references mean at least one.

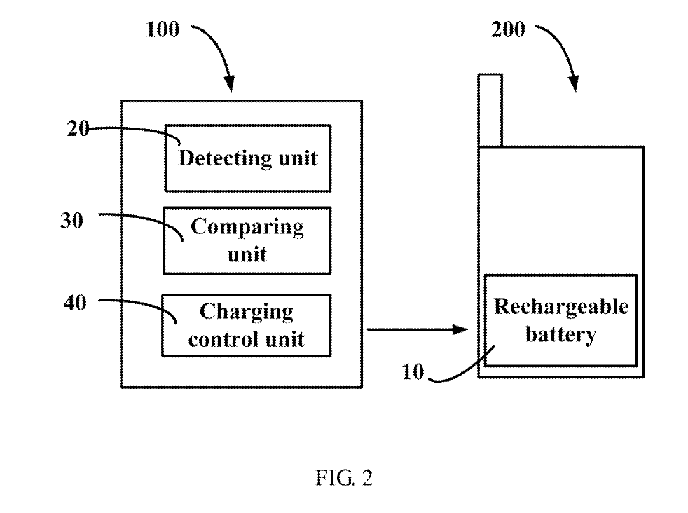

Referring to FIG. 2, a battery charging device 100 is used to charge a rechargeable battery 10 and to protect the battery 10 during the charging process. In comparison with the related art mentioned in the background, the application of the CCC phase is improved in this embodiment, and more than one different constant current I can be provided dynamically by the device 100 to charge the battery 10, based on the battery temperature T_{Bat} and the charging voltage V_{C}.

In order to prevent the battery 10 from exploding when being charged, if the temperature T_{Bat} of the battery reaches a protection temperature T_{P} or the charging voltage V_{C} reaches a protection voltage V_{P}, the charging process will end altogether.

In this embodiment, a first reference charging voltage V_{C1}, a second reference charging voltage V_{C2}, a first reference battery temperature T_{C1}, and a second reference temperature T_{C2} are established in illustrating the present disclosure. V_{C2} is less than V_{C1}, and V_{C1} is slightly less than the protection voltage V_{P}. T_{C2} is less than T_{C1}, and T_{C1} is slightly less than T_{P}. V_{C1} and T_{C1} are used to indicate the upper limits of V_{C} and T_{Bat} of the battery 10. V_{C2} and T_{C2} are used to indicate the lower limits of V_{C} and T_{Bat}. For example, for a battery 10 used in a mobile phone, V_{C} may vary from 0V to 6.8V, T_{C} may vary from 0° to 55°, V_{P} is 6.5V, T_{P} is 50°, and V_{C1} may be set as 6V, V_{C2} may be set as 2V, T_{C1} may be set as 45°, and T_{C2} may be set as 15°.

In the CCC phase, the formula for a constant current I is I=(Vc−V_{Bat})/R, where R is the resistance of the battery 10. As the resistance R is fixed and the battery voltage V_{Bat} gradually increases while the battery 10 is being charged, in order to provide a constant current (first constant charging current I₁), V_{C} should gradually increase as V_{Bat} increases to keep an unchanging difference between Vc and V_{Bat} (referred to hereafter as a first constant difference).

When V_{C} is increased to be close to V_{C1}, that is, the difference between V_{C1} and V_{C} is equal to or less than a first value, such as 0.2V, or T_{Bat} increases to be close to T_{C1}, that is, the difference between T_{C1} and T_{Bat} is equal to or less than a second value, such as 5°, V_{C} or T_{Bat} needs to be decreased to avoid the sudden cessation of battery charging. In order to maintain the charging of the battery 10 when V_{C} increases to be close to V_{C1} or T_{Bat} increases to be close to T_{C1}, the device 100 may adjust V_{C} to keep the difference between Vc and V_{Bat} at such a quantity (a second constant difference) so as to provide a smaller constant current I (second constant current I₂) to charge the battery 10, where the second constant difference is less than the first constant difference. When V_{C} is less than or equal to V_{C2} and T_{Bat} is less than or equal to T_{C2}, it indicates that the battery 10 is in fact charging slowly. In order to improve the charging efficiency, the device 100 may increase V_{C} to keep the difference between Vc and V_{Bat} at such a quantity (a third constant difference) so as to provide a further constant current (third constant current I₃) to charge the battery 10, where the third constant difference is greater than the first constant difference.

The battery charging device 100 includes a detecting unit 20, a comparing unit 30, and a charging control unit 40. The detecting unit 20 detects the battery temperature T_{Bat} and/or the charging voltage V_{C}. The comparing unit 30 compares the detected temperature T_{Bat} with temperatures T_{C1} and T_{C2}, and/or compares the detected voltage V_{C} with voltages V_{C1} and V_{C2}. The charging control unit 40 dynamically adjusts the level of Vc based on the comparison results to adjust the value of the constant currents I while charging the rechargeable battery 10 in the CCC phase.

In this embodiment, the charging control unit 40 adjusts the level of V_{C} to decrease the difference between V_{C} and V_{Bat} to decrease the charging constant current I if the difference between V_{C1} and V_{C} is equal to or less than the first value, or the difference between T_{C1} and T_{Bat} is equal to or less than the second value. The charging control unit 40 adjusts the level of V_{C} to increase the difference between V_{C} and V_{Bat} to increase the charging constant current I if V_{C} is less than or equal to V_{C2}, and T_{Bat} is less than or equal to T_{C2}. In order to make adjustments as required, the charging control unit 40 adjusts V_{C} to decrease or increase the charging constant current I at a preset interval.

In this embodiment, when the difference between V_{C1} and V_{C} is equal to or less than the first value, or the difference between T_{C1} and T_{Bat} is equal to or less than the second value, or V_{C} is less than or equal to V_{C2} and T_{Bat} is less than or equal to T_{C2}, the constant current I is deceased or increased by ΔI each time. That is, the charging control unit 40 adjusts the level of V_{C} to decrease or increase the difference between V_{C} and V_{Bat} by a value (ΔI×R). Taking ΔI as 100 mA and R as 1 Ω for example, if the current constant current I is 500 mA and V_{Bat} is 3V, the present charging voltage V_{C} is equal to (3+1×0.5)V, that is, 3.5V. When V_{Bat} increases during the charging process, V_{C} needs to be increased correspondingly to keep the difference between V_{C} and V_{Bat} at (0.5×1)V, maintaining the present current I at a constant 500 mA. If the present current I needs to be increased, the charging control unit 40 adjusts V_{C} to cause the difference between V_{C} and V_{Bat} to be increased by 0.1×1V, that is, by 0.1V, and the charging voltage needs to be increased to (3.5+0.1)V, that is, to 3.6V.

In this embodiment, in order to prevent the battery 10 from being damaged by the charging current I, a maximum current value Iₘₐₓ is defined as indicating the maximum current value that the battery 10 can endure. While increasing Vc, the charging current I may approach Iₘₐₓ. If the constant current I will be equal to or greater than the Iₘₐₓ after Vc has been increased, the charging control unit 40 may leave Vc at such a level so as to protect the battery 10. Taking the maximum current value Iₘₐₓ as 700 mA and ΔI as 100 mA for example, when the present current I is 650 mA, the charging control unit 40 will not increase V_{C} because the constant current I would reach 750 mA, which would exceed the maximum constant current Iₘₐₓ at 700 mA if Vc were to be increased.

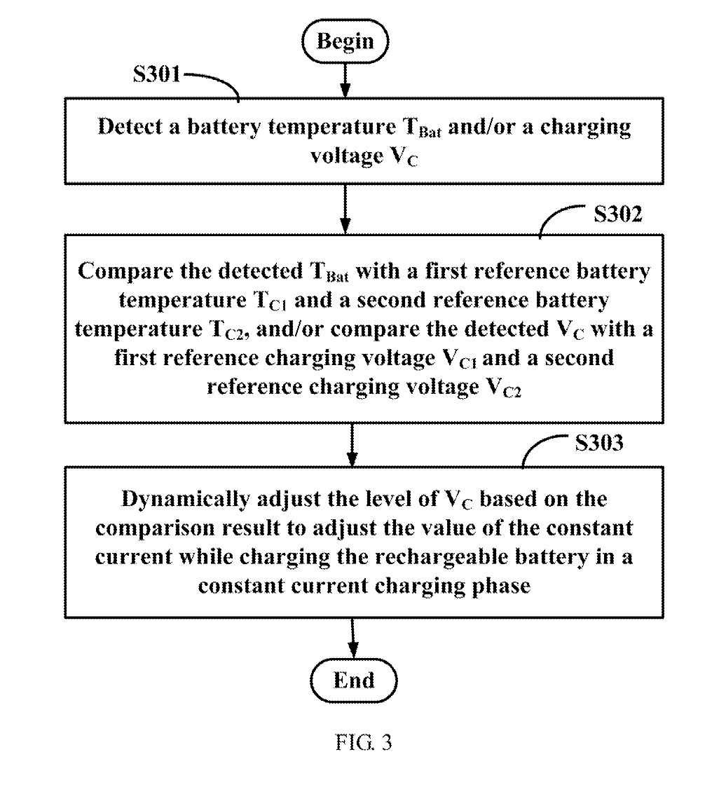

Referring to FIG. 3, a flowchart of a method for charging the rechargeable battery 10 in this disclosure is illustrated.

In step S301, the detecting unit 20 detects the battery temperature T_{Bat} and the charging voltage V_{C}.

In step 302, the comparing unit 30 compares the detected temperature T_{Bat} with temperatures T_{C1} and T_{C2}, and/or compares the detected voltage V_{C} with voltages V_{C1} and V_{C2}.

In step S303, the charging control unit 40 may dynamically adjust the level of V_{C} based on the comparison results to adjust the value of the constant current I while charging the rechargeable battery 10.

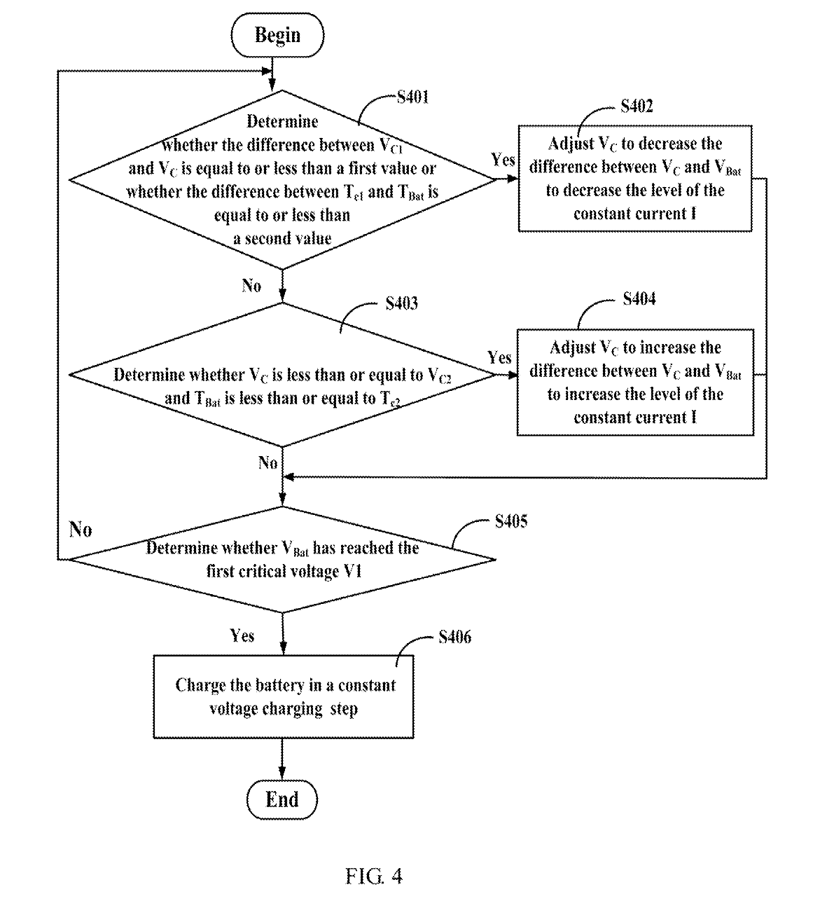

Referring to FIG. 4, a flowchart of a method for adjusting the constant current value in the charging method of FIG. 3 is illustrated.

In step S401, the comparing unit 30 determines if the difference between V_{C1} and V_{C} is equal to or less than the first value, or if the difference between T_{C1} and T_{Bat} is equal to or less than the second value. If either is found, the procedure goes to step S402, or if neither is found, the procedure goes to step S403.

In step S402, the charging unit 40 adjusts the level of V_{C} to decrease the difference between V_{C} and V_{Bat} so as to decrease the value of the constant current I.

In step S403, the comparing unit 30 determines if V_{C} is less than or equal to V_{C2}, and T_{Bat} is less than or equal to T_{C2}, and if both are found, the procedure goes to step S404, otherwise the procedure goes to step S405.

In step S404, the charging control unit 40 adjusts the level of V_{C} to increase the difference between V_{C} and V_{Bat} so as to increase the value of the constant current I.

In step S405, the comparing unit 30 determines whether V_{Bat} has reached the first critical voltage V₁, if it has, the procedure goes to step S406, and if it has not, the procedure goes to step S401.

In step S406, the battery 10 is charged in the CVC phase.

Although the current disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A battery charging device for charging a rechargeable battery, the battery charging device comprising:
a detecting unit to detect a charging voltage V_{C} and a battery temperature T_{Bat} of the rechargeable battery;
a comparing unit to compare the detected battery temperature T_{Bat} with a first reference battery temperature T_{C1} and a second reference battery temperature T_{C2}, and to compare the detected charging voltage V_{C} with a first reference charging voltage V_{C1} and a second reference charging voltage V_{C2}; and
a charging control unit to dynamically adjust the level of the charging voltage Vc based on the comparison results to adjust a value of a constant current I while charging the rechargeable battery in a constant current charging phase.

2. The battery charging device as described in claim 1, wherein the second reference charging voltage V_{C2} is less than the first reference charging voltage V_{C1}, and the first reference charging voltage V_{C1} is slightly less than a protection voltage V_{P}, the second reference battery temperature T_{C2} is less than the first reference battery temperature T_{C1}, and the first reference battery temperature T_{C1} is slightly less than a protection temperature T_{P}, the first reference charging voltage V_{C1} and the first reference battery temperature T_{C1} indicate the upper limits of the charging voltage V_{C} and the battery temperature T_{Bat}, and the second reference charging voltage V_{C2} and the second reference battery temperature T_{C2} indicate the lower limits of the charging voltage V_{C} and the battery temperature T_{Bat}.

3. The battery charging device as described in claim 2, wherein the charging control unit is further to stop charging the rechargeable battery if the charging voltage V_{C} is greater than or equal to the protection voltage V_{P} or the battery temperature T_{Bat} is greater than or equal to the protection temperature T_{P}.

4. The battery charging device as described in claim 2, wherein the charging control unit is further to adjust the level of the charging voltage V_{C} to decrease a difference between the charging voltage V_{C} and a rechargeable battery voltage V_{Bat} to decrease the charging constant current I if a difference between the first reference charging voltage V_{C1} and the charging voltage V_{C} is equal to or less than a first value, or a difference between the first reference battery temperature T_{C1} and the rechargeable battery temperature T_{Bat} is equal to or less than a second value.

5. The battery charging device as described in claim 4, wherein the charging control unit is further to adjust the level of the charging voltage V_{C} to increase the difference between the charging voltage V_{C} and the rechargeable battery voltage V_{Bat} to increase the charging constant current I if the charging voltage V_{C} is less than or equal to the second reference charging voltage V_{C2}, and the battery temperature T_{Bat} is less than or equal to the second reference battery temperature T_{C2}.

6. The battery charging device as described in claim 5, wherein the charging control unit is to adjust the level of the charging voltage V_{C} to decrease or increase the charging constant current I at a preset interval.

7. The battery charging device as described in claim 5, wherein the charging control unit is further to adjust the level of the charging voltage V_{C} to increase or decrease the difference between the charging voltage V_{C} and the rechargeable battery voltage V_{Bat} to increase or decrease the constant current I by ΔI each time.

8. The battery charging device as described in claim 5, wherein the charging control unit is further to leave the charging voltage V_{C} at such a level if the constant current I will be equal to or greater than a maximum current value Iₘₐₓ after the charging voltage Vc has been increased.

9. A charging method for charging a rechargeable battery, the charging method comprising:
providing a first reference battery temperature T_{C1}, a second reference battery temperature T_{C2}, a first reference charging voltage V_{C1}, and a second reference charging voltage V_{C2};
detecting a charging voltage V_{C} and a battery temperature T_{Bat} of the rechargeable battery;
comparing the detected battery temperature T_{Bat} with the first reference battery temperature T_{C1} and the second reference battery temperature T_{C2}, and comparing the detected charging voltage V_{C} with the first reference charging voltage V_{C1} and the second reference charging voltage V_{C2}; and
dynamically adjusting the level of the charging voltage Vc based on the comparison results to adjust a value of a constant current I while charging the rechargeable battery in a constant current charging phase.

10. The charging method as described in claim 9, wherein the second reference voltage V_{C2} is less than that of the first reference charging voltage V_{C1}, and the first charging voltage V_{C1} is slightly less than a protection voltage V_{P}, the second reference battery temperature T_{C2} is less than the first reference battery temperature T_{C1}, and the first reference battery temperature T_{C1} is slightly less than a protection temperature T_{P}, the first reference charging voltage V_{C1} and the first reference battery temperature T_{C1} indicate the upper limits of the charging voltage V_{C} and the battery temperature T_{Bat}, and the second reference charging voltage V_{C2} and the second reference battery temperature T_{C2} indicate the lower limits of the charging voltage V_{C} and the battery temperature T_{Bat}.

11. The charging method as described in claim 10, wherein the process of charging the rechargeable battery is controlled to be stopped if the charging voltage V_{C} is greater than or equal to the protection voltage V_{P} or the battery temperature T_{Bat} is greater than or equal to the protection temperature T_{P}.

12. The charging method as described in claim 10, wherein the adjusting step comprises adjusting the level of the charging voltage V_{C} to decrease a difference between the charging voltage V_{C} and a rechargeable battery voltage V_{Bat} to decrease the charging constant current I if a difference between the first reference charging voltage V_{C1} and the charging voltage V_{C} is equal to or less than a first value, or a difference between the first reference battery temperature T_{C1} and the rechargeable battery temperature T_{Bat} is equal to or less than a second value.

13. The charging method as described in claim 12, wherein the adjusting step further comprises adjusting the level of the charging voltage V_{C} to increase the difference between the charging voltage V_{C} and the rechargeable battery voltage V_{Bat} to increase the charging constant current I if the charging voltage V_{C} is less than or equal to the second reference charging voltage V_{C2}, and the battery temperature T_{Bat} is less than or equal to the second reference battery temperature T_{C2}.

14. The charging method as described in claim 13, wherein the level of the charging voltage V_{C} is adjusted to decrease or increase the charging constant current I at a preset interval.

15. The charging method as described in claim 13, wherein the level of the charging voltage V_{C} is adjusted to increase or decrease the difference between the charging voltage V_{C} and the rechargeable battery voltage V_{Bat} to increase or decrease the constant current I by ΔI each time.

16. The charging method device as described in claim 13, wherein the charging voltage V_{C} is leaved at such a level if the constant current I will be equal to or greater than a maximum current value Iₘₐₓ after the charging voltage Vc has being increased.

17. A battery charging device for charging a rechargeable battery, the battery charging device comprising:
a detecting unit to detect a charging voltage V_{C} or a battery temperature T_{Bat} of the rechargeable battery;
a comparing unit to compare the detected battery temperature T_{Bat} with a first reference battery temperature T_{C1} and a second reference battery temperature T_{C2}, or to compare the detected charging voltage V_{C} with a first reference charging voltage V_{C1} and a second reference charging voltage V_{C2}; and
a charging control unit to dynamically adjust the level of the charging voltage Vc based on the comparison results to adjust a value of a constant current I while charging the rechargeable battery in a constant current charging phase.

18. The battery charging device as described in claim 17, wherein the second reference charging voltage V_{C2} is less than the first reference charging voltage V_{C1}, and the first reference charging voltage V_{C1} is slightly less than a protection voltage V_{P}, the second reference battery temperature T_{C2} is less than the first reference battery temperature T_{C1}, and the first reference battery temperature T_{C1} is slightly less than a protection temperature T_{P}, the first reference charging voltage V_{C1} and the first reference battery temperature T_{C1} indicate the upper limits of the charging voltage V_{C} and the battery temperature T_{Bat}, and the second reference charging voltage V_{C2} and the second reference battery temperature T_{C2} indicate the lower limits of the charging voltage V_{C} and the battery temperature T_{Bat}.

19. The battery charging device as described in claim 18, wherein the charging control unit is further to stop charging the rechargeable battery if the charging voltage V_{C} is greater than or equal to the protection voltage V_{P} or the battery temperature T_{Bat} is greater than or equal to the protection temperature T_{P}.

20. The battery charging device as described in claim 18, wherein the charging control unit is further to adjust the level of the charging voltage V_{C} to decrease a difference between the charging voltage V_{C} and a rechargeable battery voltage V_{Bat} to decrease the charging constant current I if a difference between the first reference charging voltage V_{C1} and the charging voltage V_{C} is equal to or less than a first value, or a difference between the first reference battery temperature T_{C1} and the rechargeable battery temperature T_{Bat} is equal to or less than a second value.
